(19) United States
(12) Patent Application Publication
(10) Pub. No.: US 2026/0270173 A1
(43) Pub. Date: Sep. 10, 2026

(54) COMMUNICATION METHOD

(71) Applicant: TENCENT TECHNOLOGY (SHENZHEN) COMPANY LIMITED, Shenzhen (CN)

(72) Inventor: Yixue LEI, Shenzhen (CN)

(73) Assignee: TENCENT TECHNOLOGY (SHENZHEN) COMPANY LIMITED, Shenzhen (CN)

(21) Appl. No.: 19/664,292

(22) Filed: Apr. 30, 2026

Related U.S. Application Data
(63) Continuation of application No. PCT/CN2024/109044, filed on Jul. 31, 2024.

(30) Foreign Application Priority Data
Dec. 12, 2023 (CN) 202311710490.X

(51) Int. Cl. H04L 43/0817; H04L 65/1069; H04L 69/322

(52) U.S. Cl. CPC H04L 43/0817; H04L 65/1069; H04L 69/322

(57) ABSTRACT

In a communication method, a first message is generated by processing circuitry of a communication device configured as a first network element in a communication network, the first message including quality of service (QoS) monitoring-related information of the first network element, and the QoS monitoring-related information including QoS monitoring capability information indicating a QoS monitoring capability supported by the first network element. In the method, the first message is transmitted to a second network element in the communication network irrespective of whether the first network element is configured to perform a QoS monitoring operation.

### RELATED APPLICATIONS

The present application is a continuation of International Application No. PCT/CN2024/109044, filed on Jul. 31, 2024, which claims priority to Chinese Patent Application No. 202311710490.X, filed on Dec. 12, 2023, and entitled “COMMUNICATION METHOD AND APPARATUS, COMPUTER-READABLE MEDIUM, AND ELECTRONIC DEVICE.” The entire disclosures of the prior applications are hereby incorporated by reference.

### FIELD OF THE TECHNOLOGY

This disclosure relates to the field of computer and communication technologies, including a communication method and apparatus, a computer-readable medium, and an electronic device.

### BACKGROUND OF THE DISCLOSURE

In a mobile communication network, with the increase of service diversity, quality of service (QoS) monitoring capability may be relevant to satisfy different service requirements and improve network performance. For example, in scenarios in which a high-bandwidth QoS-sensitive service such as extended reality (XR) or XR and media services (XRM) is introduced, and in which industrial control, remote driving, and the like are supported, the QoS monitoring capability plays a more prominent role.

In some scenarios, because QoS monitoring-related information of a device on a radio access network (RAN) side and QoS monitoring-related information of a core network device may be different, a problem of being unsupported occurs after an end-to-end QoS monitoring request is initiated, and as a result, reliability and processing performance of a multimedia service may be affected.

### SUMMARY

Embodiments of this disclosure provide a communication method and apparatus, a computer-readable medium, and an electronic device. A problem that whether quality of service (QoS) monitoring can be performed cannot be predicted when a QoS-sensitive service is processed, thereby facilitating improving reliability and processing performance of a target service such as the QoS-sensitive service.

According to a first aspect, this disclosure provides a communication method. In the method, a first message is generated by processing circuitry of a communication device configured as a first network element in a communication network, the first message including quality of service (QoS) monitoring-related information of the first network element, and the QoS monitoring-related information including QoS monitoring capability information indicating a QoS monitoring capability supported by the first network element. In the method, the first message is transmitted to a second network element in the communication network irrespective of whether the first network element is configured to perform a QoS monitoring operation.

According to a second aspect, this disclosure provides a communication device configured as a first network element in a communication network, and the communication device includes processing circuitry configured to generate a first message that includes quality of service (QoS) monitoring-related information of the first network element, and the QoS monitoring-related information including QoS monitoring capability information indicating a QoS monitoring capability supported by the first network element. The processing circuitry is configured to transmit the first message to a second network element in the communication network irrespective of whether the first network element is configured to perform a QoS monitoring operation.

According to a third aspect, this disclosure provides a non-transitory computer-readable storage medium storing instructions, which when executed by a processor of a communication device configured as a first network element, cause the processor to perform a communication method. In the method, a first message that includes quality of service (QoS) monitoring-related information of the first network element is generated, and the QoS monitoring-related information includes QoS monitoring capability information indicating a QoS monitoring capability supported by the first network element. In the method, the first message is transmitted to a second network element in the communication network irrespective of whether the first network element is configured to perform a QoS monitoring operation.

According to a fourth aspect, this disclosure provides a communication method, performed by a first network element, the communication method including: generating a first message, the first message including QoS monitoring-related information of the first network element; and transmitting the first message to a second network element, to synchronize the QoS monitoring-related information of the first network element to the second network element.

According to a fifth aspect, this disclosure provides a communication apparatus, used in a first network element, the communication apparatus including: a generation unit, configured to generate a first message, the first message including QoS monitoring-related information of the first network element; and a transmitting unit, configured to transmit the first message to a second network element, to synchronize the QoS monitoring-related information of the first network element to the second network element.

According to a sixth aspect, this disclosure provides a computer-readable medium, having a computer program stored therein, the computer program, when being executed by a processor, implementing the communication method according to the foregoing embodiment.

According to a seventh aspect, this disclosure provides an electronic device, the electronic device including: one or more processors; and a storage apparatus, configured to store one or more computer programs, the one or more computer programs, when being executed by the one or more processors, enabling the electronic device to implement the communication method according to the foregoing embodiment.

According to an eighth aspect, this disclosure provides a computer program product, the computer program product including a computer program, and the computer program being stored in a non-transitory computer-readable storage medium. Processing circuitry (e.g., a processor) of the electronic device reads and executes the computer program from the non-transitory computer-readable storage medium, which enables the electronic device to perform the communication method provided in one or more embodiments of this disclosure.

In various technical solutions provided in this disclosure, the first network element generates the first message including the QoS monitoring-related information of the first network element, and transmits the first message to the second network element, to synchronize the QoS monitoring-related information of the first network element to the second network element, so that the network elements can synchronize the QoS monitoring-related information, thereby resolve the issue of ascertaining whether a QoS monitoring operation can be performed when the QoS-sensitive service is processed. This facilitates improving the reliability and the processing performance of a target service (such as the QoS-sensitive service), and to better satisfy requirements for real-time control and data transmission.

The foregoing general descriptions and the following detailed descriptions are illustrative, and are not intended to limit the scope of this disclosure.

### BRIEF DESCRIPTION OF THE DRAWINGS

FIG. 1 is a schematic diagram of a system architecture to which technical solutions of embodiments of this disclosure can be applied.

FIG. 2 is a flowchart of a communication method according to an embodiment of this disclosure.

FIG. 3 is a flowchart of a communication method according to an embodiment of this disclosure.

FIG. 4 is a schematic diagram of an architecture of a plurality of network elements of a 5G network.

FIG. 5 is a flowchart in which a gNB and a 5GC network element synchronize QoS monitoring capability information according to an embodiment of this disclosure.

FIG. 6 is a flowchart of PDU session establishment.

FIG. 7 is a block diagram of a communication apparatus according to an embodiment of this disclosure.

FIG. 8 is a schematic diagram of a structure of a computer system suitable for implementing one or more embodiments of this disclosure.

### DETAILED DESCRIPTION

Embodiments of this disclosure are described with reference to accompanying drawings. However, examples described herein may be implemented in various forms, and are not to be understood as being limited to these examples.

In addition, features, structures, or characteristics described in this disclosure may be combined in any appropriate manner in one or more embodiments. Other technical solutions of this disclosure may be implemented without using all detailed features in one or more embodiments described herein, one or more particular details may be omitted, or other methods, elements, apparatuses, or operations may be used.

Descriptions of terms in this disclosure are provided as examples only and are not intended to limit the scope of the disclosure.

In one or more embodiments of this disclosure, the term “module” or “unit” refers to a computer program or a part of a computer program having a predetermined function, and works together with other related parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

Block diagrams shown in the accompany drawings are functional entities and do not necessarily correspond to physically independent entities. In some examples, these functional entities may be implemented in a software form, or these functional entities may be implemented in one or more hardware modules or integrated circuits, or these functional entities may be implemented in different networks and/or processor apparatuses and/or microcontroller apparatuses.

The flowcharts shown in the accompanying drawings are non-limiting examples, do not need to include all content and operations/steps, and are not required to be performed in the described orders. For example, some operations/steps may be further divided, while some operations/steps may be combined or partially combined. Therefore, an actual execution order may change based on an actual situation.

The term “plurality of” mentioned herein refers to two or more. The term “and/or” describes an association relationship between associated objects and represents that three relationships may exist. For example, A and/or B may represent the following three cases: only A exists, both A and B exist, and only B exists. The character “/” denotes an “or” relationship between the associated objects.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

With the development of 5^{th}-Generation (5G) and subsequent evolved systems (such as 5G-A and 6G), a plurality of multimedia services that require a large amount of data and a short delay are applied, For example, an interaction service such as a cloud game service, virtual reality (VR), augmented reality (AR), mixed reality (MR), extended reality (XR), or image reality (CR).

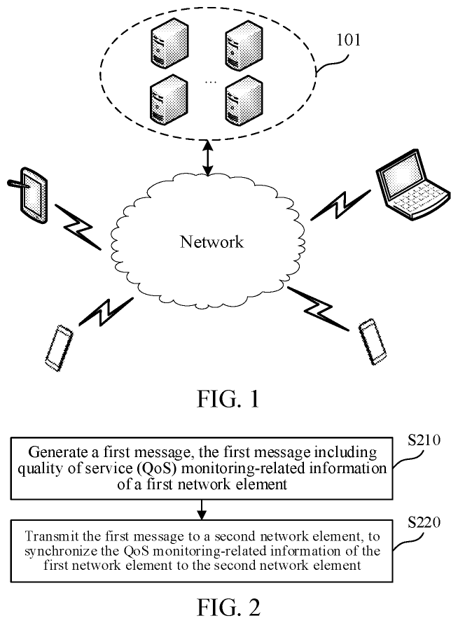

For example, in a cloud game scenario shown in FIG. 1, a cloud server 101 is configured to run a cloud game. The cloud server 101 may render a game picture, encode an audio signal and the rendered image, and finally transmit coded data obtained by encoding processing to game clients through a network. The game client may be a user equipment (UE), such as a smartphone, a tablet computer, a notebook computer, a desktop computer, a smart television, a smart household, an in-vehicle terminal, or an aircraft, having a basic streaming media playing capability, a human-computer interaction capability, a communication capability, and the like. Alternatively, the game client may be an application program running in a terminal device. In at least one aspect, the game client may decode the encoded data transmitted by the cloud server 101, to obtain an analog audio and video signal, and play the analog audio and video signal.

FIG. 1 shows an example of a system architecture representing a cloud game system, and does not limit a specific architecture of the cloud game system. For example, in other embodiments, the cloud game system may further include a backend server configured to perform scheduling and the like. In addition, the cloud server 101 may be an independent physical server, or may be a server cluster formed by a plurality of physical servers or a distributed system, or may be a cloud server providing basic cloud computing services, for example, a cloud service, a cloud database, cloud computing, a cloud function, cloud storage, a network service, cloud communication, a middleware service, a domain name service, a security service, a content delivery network (CDN), and a big data and artificial intelligence platform. The game client and the cloud server 101 may be directly or indirectly connected by using a wired or wireless communication manner. This is not limited in this disclosure.

The foregoing multimedia service requires a network to provide a high data rate, a low delay, and better connection reliability. Therefore, a function of a quality of service (QoS) monitoring capability is more prominent. In a 5G network, QoS monitoring relates to monitoring of a plurality of network elements and a plurality of parameters, for example, an uplink (UL) delay, a downlink (DL) delay, a round-trip time (RTT) delay, network congestion information, a network transmission rate, and network delay jitter information. The monitoring of these parameters may be relevant to evaluating network performance and improving quality of service.

However, in actual network deployment, QoS monitoring-related information of a device on an RAN side and QoS monitoring-related information of a core network device may be different. For example, supported QoS monitoring capabilities may be different. In at least one aspect, for example, some devices may not support some particular QoS monitoring parameters, or supported measurement granularities may be inconsistent. In addition, measurement of some QoS monitoring parameters may also be completed after a plurality of devices cooperate. For example, measurement of RTT delay may be supported by a RAN and a user plane function (UPF).

In this case, after end-to-end QoS monitoring is initiated, some devices may not provide a required QoS monitoring capability, resulting in that the network performance and quality cannot be correctly evaluated. This may cause the network to fail to satisfy requirements for real-time control and data transmission, and further may negatively affect a target application such as industrial control or remote driving.

In view of the foregoing problem, one or more embodiments of this disclosure provide a new communication solution, which can allow synchronization of the QoS monitoring capability between the network elements, for example, synchronization of QoS monitoring-related information in processes such as interface establishment, network element discovery, and protocol data unit (PDU) session establishment/modification, thereby the network elements in the network can work more collaboratively, and a consistent QoS monitoring capability is provided. This helps improve quality of service and reliability of the target application such as the industrial control or the remote driving, thereby better satisfying the requirements for the real-time control and the data transmission.

The implementation details of one or more embodiments of this disclosure are described in detail below.

FIG. 2 is a flowchart of a communication method according to an embodiment of this disclosure. The communication method may be performed by a first network element. The first network element may be an access network element such as a base station. The first network element may alternatively be a core network element, for example, another network element such as an access and mobility management function (AMF), a session management function (SMF), a user plane function (UPF), or a policy control function (PCF). With reference to FIG. 2, the communication method includes at least S210 and S220. A detailed description is as follows:

S210: Generate a first message, the first message including QoS monitoring-related information of the first network element. For example, a first message is generated by processing circuitry of a communication device configured as a first network element in a communication network, the first message including quality of service (QoS) monitoring-related information of the first network element, and the QoS monitoring-related information including QoS monitoring capability information indicating a QoS monitoring capability supported by the first network element.

In some embodiments, the QoS monitoring-related information may include at least one of the following information: QoS monitoring configuration information, QoS monitoring parameter information, and QoS monitoring capability information. The QoS monitoring capability information indicates whether a network element supports monitoring a network parameter, and a network parameter supported by the network element to monitor. In some embodiments, the QoS monitoring capability information can represent monitoring some or all of the following network parameters: a UL delay, a DL delay, an RTT delay, network congestion information (which may be uplink network congestion information, downlink network congestion information, or uplink and downlink network congestion information), a network transmission rate (which may be an uplink network transmission rate, a downlink network transmission rate, or an uplink and downlink network transmission rate), network delay jitter information (which may be uplink network delay jitter information, downlink network delay jitter information, or uplink and downlink network delay jitter information), and the like.

In some embodiments, the QoS monitoring configuration information may include one or more pieces of information such as a QoS parameter, a monitored target, a monitoring period, an alarm threshold, data storage and analysis, and access control.

The QoS parameter defines a required quality of service level, for example, a bandwidth, a delay, a jitter, and a packet loss rate. These parameters may be adjusted and optimized based on different service requirements. The monitored target may include a network device, a link, or an application program that is identified to be monitored, and QoS monitoring configuration may be different based on different monitored targets. The monitoring period refers to a time interval at which QoS monitoring, for example, real-time monitoring or periodical monitoring, is performed. The real-time monitoring can provide more timely data, and the periodical monitoring can evaluate network performance within a longer time range. The alarm threshold triggers an alarm when the QoS parameter is greater than or lower than a pre-determined threshold. Setting of the alarm threshold may be adjusted based on a service requirement and a network performance requirement. The data storage and analysis are configured for processing data generated by the QoS monitoring, to evaluate and optimize the network performance. The access control is configured for specifying a user or device that can access the QoS monitoring data.

In some embodiments, the QoS monitoring parameter information may include one or more pieces of information such as a network traffic parameter, a delay parameter, a packet loss rate parameter, a jitter parameter, an error rate parameter, a connectivity parameter, a reliability parameter, and a load parameter.

The network traffic parameter includes a quantity of inputted/outputted bytes, a quantity of inputted/outputted packets, bandwidth utilization, and the like, and can reflect an overall condition of network traffic. The delay parameter includes an end-to-end delay, a transmission delay, a processing delay, and the like, and is configured for measuring delay conditions of a network service at various layers (including a physical layer, a data link layer, a transport layer, and the like). The packet loss rate parameter includes an input/output packet loss rate, a retransmission rate, and the like, and is configured for measuring a packet loss condition of a network in a transmission process. The jitter parameter includes an input/output jitter, a maximum/minimum jitter, and the like, and is configured for measuring jitter conditions of a network service at various layers. The error rate parameter includes an input/output error rate, and the like, and is configured for measuring an error condition of a network in a transmission process. The connectivity parameter includes a connection establishment success rate, a connection interruption rate, and the like, and is configured for measuring connectivity of a network. The reliability parameter includes an error retransmission rate, error recovery time, and the like, and is configured for measuring reliability of a network service. The load parameter includes a network load condition, a server load condition, and the like, and is configured for measuring a load condition of a network.

In some embodiments, the first message is used by the first network element to synchronize the QoS monitoring-related information of the first network element to another network element. The first message may reuse a related message in a communication standard, or may be a newly added message.

S220: Transmit the first message to a second network element, to synchronize the QoS monitoring-related information of the first network element to the second network element. For example, the first message is transmitted to a second network element in the communication network irrespective of whether the first network element is configured to perform a QoS monitoring operation.

In some embodiments, the second network element is a network element that can communicate with the first network element. For example, when the first network element is an access network element, the second network element may be a core network element. When the first network element is a core network element, the second network element may be an access network element, or may be another core network element.

In some embodiments, if the first network element is the access network element, the first message may be an NG interface setup request message (that is, an NG setup request). In this case, the access network element may transmit the NG interface setup request message including QoS monitoring-related information of the access network element to an AMF, so that the AMF can obtain the QoS monitoring-related information of the access network element, and the AMF can synchronize the QoS monitoring-related information of the access network element to another core network element during subsequent interaction to the another core network element, for example, synchronize the QoS monitoring-related information of the access network element to an SMF, a PCF, or a UPF. The NG interface refers to an interface between a radio access network and a 5G core network. In another embodiment of this disclosure, the access network element may alternatively transmit the QoS monitoring-related information of the access network element to the AMF by using a message of another type.

In some embodiments, if the first network element is the access network element, the access network element may further transmit the first message to a UPF through a user plane. In this case, the UPF may obtain the QoS monitoring-related information of the access network element, and the UPF may transfer the QoS monitoring-related information of the access network element to a performance measurement function (PMF).

In some embodiments, if the first network element is the AMF, the first message may be one of a session management context creation request message (that is, a CreateSMContext Request), an N1N2 information transfer message (that is, N1N2MessageTransfer), and a session management context update request message (that is, an UpdateSMContext Request). In this case, the second network element may be an SMF. In one or more embodiments, QoS monitoring-related information of the AMF may be transferred to the SMF by using a signaling message in a PDU session establishment process or modification process. In another embodiment, the AMF may alternatively transmit the QoS monitoring-related information of the AMF to the SMF by using a message of another type.

In some embodiments, if the first network element is the AMF, the first message may be a PDU session request message (that is, a PDU Session Request), and the second network element may be an access network element. In another embodiment, the AMF may alternatively transmit the QoS monitoring-related information of the AMF to the access network element by using a message of another type.

In some embodiments, if the first network element is the SMF, the first message may be one of a session management context creation response message (that is, a CreateSMContext Response), an N1N2 information transfer message (that is, N1N2MessageTransfer), a session management context update response message (UpdateSM Context Response), and a session management context status notification message (that is, SMContextStatus Notify). In this case, the second network element may be an AMF. In one or more embodiments, QoS monitoring-related information of the SMF may be transferred to the AMF by using a signaling message in a PDU session establishment process or modification process. In another embodiment, the SMF may alternatively transmit the QoS monitoring-related information of the SMF to the AMF by using a message of another type.

In some embodiments, if the first network element is the SMF, the first message may be a message in a session management policy association establishment process (that is, SM Policy Association Establishment) or a session management policy association modification process (SM Policy Association Modification, that may be a modification process initiated by the SMF). In this case, the second network element may be a PCF. In another embodiment, the SMF may alternatively transmit the QoS monitoring-related information of the SMF to the PCF by using a message of another type.

In some embodiments, if the first network element is the SMF, the first message may be a session establishment request message (that is, an N4 Session Establishment Request) or a session modification request message (that is, an N4 Session Modification Request). In this case, the second network element may be a UPF. In another embodiment, the SMF may alternatively transmit the QoS monitoring-related information of the SMF to the UPF by using a message of another type.

In some embodiments, if the first network element is the PCF, the first message may be a message in a session management policy association establishment process (that is, the SM Policy Association Establishment) or a session management policy association modification process (SM Policy Association Modification, that may be the modification process initiated by the SMF). In this case, the second network element may be an SMF. In another embodiment, the PCF may alternatively transmit the QoS monitoring-related information of the PCF to the SMF by using a message of another type.

In some embodiments, if the first network element is the UPF, the first message may be a session establishment response message (that is, an N4 Session Establishment Response) or a session modification response message (that is, an N4 Session Modification Response). In this case, the second network element may be an SMF. In another embodiment, the UPF may alternatively transmit QoS monitoring-related information of the UPF to the SMF by using a message of another type.

In some embodiments, the first message transmitted by the first network element to the second network element may further include QoS monitoring-related information of another network element interacting with the first network element. For example, if the first network element is the AMF, when transmitting the QoS monitoring-related information of the AMF to the SMF by using the first message, the AMF may also add the QoS monitoring-related information of the access network element. In this way, the QoS monitoring-related information of the access network element may be transferred in a core network element.

In some embodiments, in addition to transmitting, by the first network element, the first message to the second network element to synchronize the QoS monitoring-related information of the first network element, the second network element may also transmit a second message to the first network element. The second message may include QoS monitoring-related information of the second network element, or include QoS monitoring-related information of another network element interacting with the second network element, or include the QoS monitoring-related information of the second network element and the QoS monitoring-related information of the another network element interacting with the second network element. For example, if the first network element is the access network element, and the second network element is the AMF, a second message transmitted by the AMF to the access network element may include QoS monitoring-related information of the AMF, or may include QoS monitoring-related information of an SMF, or may include the QoS monitoring-related information of the AMF, the QoS monitoring-related information of the SMF, and QoS monitoring-related information of a UPF.

Based on the foregoing embodiments of this disclosure, if the AMF obtains the QoS monitoring-related information of the SMF, the AMF may select, based on the QoS monitoring-related information of the SMF in a PDU session establishment process, an SMF configured for establishing a PDU session. For example, an SMF that supports the QoS monitoring capability information or supports a large quantity of QoS monitoring capability items may be selected.

If the SMF obtains the QoS monitoring-related information of the PCF, the SMF may select, based on the QoS monitoring-related information of the PCF in a PDU session establishment process, a PCF configured for establishing a PDU session. For example, a PCF that supports the QoS monitoring capability information or supports a large quantity of QoS monitoring capability items may be selected.

If the SMF obtains the QoS monitoring-related information of the UPF, the SMF may select, based on the QoS monitoring-related information of the UPF in a PDU session establishment process, a UPF configured for establishing a PDU session. For example, a UPF that supports the QoS monitoring capability information or supports a large quantity of QoS monitoring capability items may be selected.

Non-limiting examples of this disclosure are described below by using a non-limiting example in which the first network element is the access network element (for example, the base station), and the second network element is the AMF.

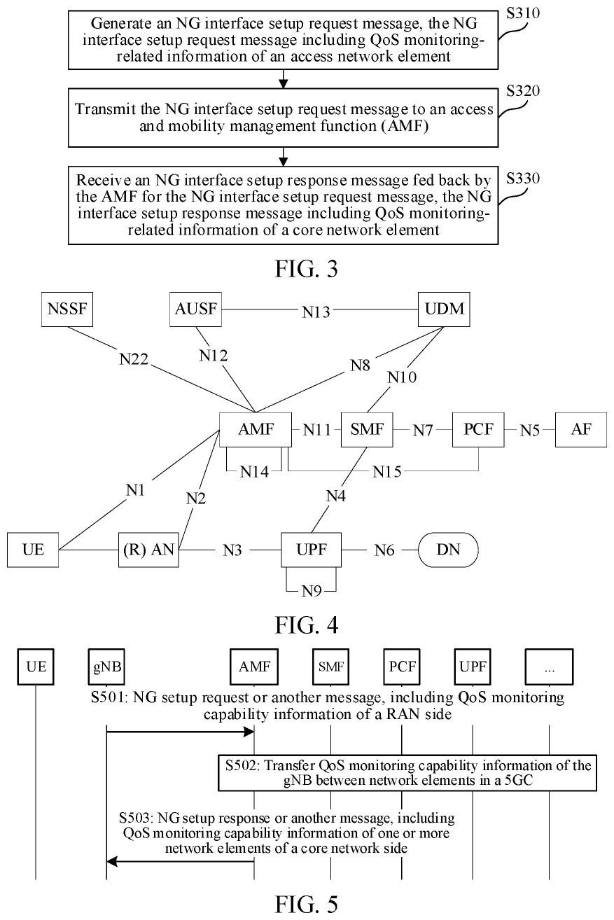

FIG. 3 is a flowchart of a communication method according to an embodiment of this disclosure. The communication method may be performed by an access network element. With reference to FIG. 3, the communication method includes at least S310 to S330. A detailed description is as follows:

S310: Generate an NG interface setup request message, the NG interface setup request message including QoS monitoring-related information of the access network element.

In one or more embodiments shown in FIG. 3, the access network element can reuse the NG interface setup request message to transmit the QoS monitoring-related information of the access network element to an AMF.

In some embodiments, an information element (IE for short), that is, a first information element, may be newly added to the NG interface setup request message. The first information element indicates the QoS monitoring-related information of the access network element. In some embodiments, the first information element may be represented as a QoS Monitoring Capability.

In some embodiments, if the QoS monitoring-related information includes QoS monitoring capability information, an element value corresponding to the first information element may include at least one flag bit. Each flag bit corresponds to one QoS monitoring capability item. A value of the flag bit indicates whether the access network element supports a corresponding QoS monitoring capability item.

For example, the QoS monitoring capability items included in the QoS monitoring capability information are sequentially a link delay, round-trip time, network congestion information, a network transmission rate, and network delay jitter information. In this case, the element value corresponding to the first information element may include five flag bits. Assuming that 1 represents support and 0 represents no support, “10110” indicates that the access network element supports link delay monitoring, does not support round-trip time monitoring, supports network congestion information monitoring, supports network transmission rate monitoring, and does not support network delay jitter information monitoring.

S320: Transmit the NG interface setup request message to an AMF.

In some embodiments, after the access network element transmits the NG interface setup request message to the AMF, the AMF may obtain the QoS monitoring-related information of the access network element. In this case, the AMF may select whether to transfer the QoS monitoring-related information of the access network element to another core network element (such as an SMF or a UPF).

S330: Receive an NG interface setup response message fed back by the AMF for the NG interface setup request message, the NG interface setup response message including QoS monitoring-related information of a core network element.

In some embodiments, the AMF can reuse an NG interface setup response message to transmit the QoS monitoring-related information of the core network element to the access network element. In some embodiments, the QoS monitoring-related information of the core network element included in the NG interface setup response message may be one or more of QoS monitoring-related information of the AMF, QoS monitoring-related information of an SMF, QoS monitoring-related information of a PCF, and QoS monitoring-related information of a UPF.

In some embodiments, an IE, that is, a second information element, may be newly added to the NG interface setup response message. The second information element indicates QoS monitoring-related information of a core network element (for example, the AMF). In some embodiments, the second information element may be represented as a QoS Monitoring Capability Core Network (CN).

In some embodiments, if the QoS monitoring-related information includes QoS monitoring capability information, an element value corresponding to the second information element may include at least one flag bit. Each flag bit corresponds to one QoS monitoring capability item. A value of the flag bit indicates whether the core network element supports a corresponding QoS monitoring capability item.

For example, the QoS monitoring capability items included in the QoS monitoring capability information are sequentially the link delay, the round-trip time, the network congestion information, the network transmission rate, and the network delay jitter information. In this case, the element value corresponding to the second information element may include five flag bits. Assuming that 1 represents support, and 0 represents no support, “10110” indicates that the core network element supports the link delay monitoring, does not support the round-trip time monitoring, supports the network congestion information monitoring, supports the network transmission rate monitoring, and does not support the network delay jitter information monitoring.

As such, one or more embodiments of this disclosure provide a solution of actively synchronizing the QoS monitoring-related information. This solution can allow to synchronize the QoS monitoring-related information between the network elements, for example, synchronize the QoS monitoring-related information in an interface establishment process, a network element discovery process, and a PDU session establishment/modification process, so that the network elements in the network can work more collaboratively, thereby addressing an issue that whether QoS monitoring can be performed cannot be predicted when a 5G network carries a QoS-sensitive service such as XRM, industrial control, and remote driving control.

In one or more embodiments of this disclosure, negotiation of the QoS monitoring-related information may be performed at an interface establishment stage or a network element discovery stage. In at least one aspect, FIG. 4 shows an architecture of a plurality of network elements of a 5G network defined by the 3^{rd} generation partnership project (3GPP) organization. An AMF, an SMF, a UPF, a PCF, a network slice selection function (NSSF), an authentication server function (AUSF), a unified data management (UDM), and the like are core network elements of the 5G network. User equipment (UE) may be a 5G terminal such as a mobile phone or a tablet computer. A (radio) access network ((R)AN) may be a 5G base station. A data network (DN) may correspond to a service server accessed by the UE.

The AMF is responsible for terminating an N2 interface of a control plane of the base station, and implementing encoding and decoding of a next generation application protocol (NGAP) based on a stream control transmission protocol (SCTP). The base station and the AMF transmit the application layer protocol NGAP by using the transport layer protocol SCTP, and carry NAS signaling data of the UE in the NGAP. The AMF is further responsible for terminating an N1 interface of the UE and implementing encryption and integrity protection of a non-access stratum (NAS), responsible for functions such as UE access authentication, authorization management, registration, connection, reachability, and mobility management, and responsible for transparently transmitting a session management message between the UE and the SMF.

In addition, the (R)AN interacts with the UPF through an N3 interface. UPFs can interact with each other through an N9 interface. The UPF interacts with the SMF through an N4 interface. The UPF interacts with the DN through an N6 interface. The SMF interacts with the AMF through an N11 interface. The SMF interacts with the PCF through an N7 interface. The SMF interacts with the UDM through an N10 interface. The PCF interacts with the AF through an N5 interface. The AMFs can interact with each other through an N14 interface. The AMF interacts with the PCF through an N15 interface. The AMF interacts with the UDM through an N8 interface. The AMF interacts with the NSSF through an N22 interface. The AMF interacts with the AUSF through an N12 interface. The AUSF interacts with the UDM through an N13 interface.

Based on the system architecture shown in FIG. 4, in a network element discovery process or a connection establishment process between the core network elements, QoS monitoring-related information may be synchronized based on the corresponding interaction interfaces. When establishing an N2/N3 RAN-CN interface, an access network element (that is, the base station) and the core network element may negotiate for QoS monitoring-related information.

In some embodiments, the QoS monitoring-related information may include at least one of the following information: QoS monitoring configuration information, QoS monitoring parameter information, and the QoS monitoring capability information. An example in which the QoS monitoring-related information is the QoS monitoring capability information is used below to describe the implementation details of one or more embodiments of this disclosure in detail.

In a non-limiting example, as shown in FIG. 5, capability information related to QoS Monitoring may be added to an NG setup request and an NG setup response of an N2 interface between a gNB and a 5G core (5GC) network. A basic procedure of this embodiment includes:

S501: The gNB transmits, to an AMF, an NG setup request message or another message including QoS monitoring capability information of a RAN side.

In S501, the QoS monitoring capability information is synchronized from the gNB to a core network. For example, an IE (for example, the QoS Monitoring Capability) configured for representing a QoS Monitoring capability may be added to a message (for example, the NG setup request or the another message) transmitted by the gNB to the AMF, to indicate the QoS monitoring capability information of the gNB. The QoS monitoring capability information may include network congestion monitoring, delay monitoring, RTT monitoring, and the like, and may also include another monitoring item. To flexibly reflect different aspects of the QoS monitoring capability, the capability IE may use different bitmaps to indicate different QoS monitoring capability items of the gNB. For example, the QoS monitoring capability items included in the QoS monitoring capability information are sequentially a link delay, round-trip time, network congestion information, a network transmission rate, and network delay jitter information. In this case, the bitmap may include five flag bits. Assuming that 1 represents support, and 0 represents no support, “10110” represents that the gNB supports link delay monitoring, does not support round-trip time monitoring, supports network congestion information monitoring, supports network transmission rate monitoring, and does not support network delay jitter information monitoring.

In some embodiments, to notify the QoS monitoring capability information possible core network elements in advance, the gNB may provide the QoS monitoring capability information of the gNB for a plurality of AMFs or UPFs. In some embodiments, when providing the QoS monitoring capability information of the gNB for the UPF, the gNB may provide the QoS monitoring capability information through a control plane, or may provide the QoS monitoring capability information through a user plane instead of the AMF. For example, the gNB may provide the QoS monitoring capability information of the gNB for the AMF through the N3 interface shown in FIG. 4.

S502: After obtaining the QoS monitoring capability information of the RAN side, the AMF may transfer the QoS monitoring capability information of the gNB between network elements in the 5GC.

In some embodiments, after obtaining the QoS monitoring capability information of the gNB, the AMF may use the QoS monitoring capability information in a subsequent PDU session establishment procedure, PDU session modification procedure, or handover process, and may synchronously enable an SMF performing PDU session management, a PCF performing policy control, and a UPF implementing a user plane function to all obtain the QoS monitoring capability information of the gNB.

S503: The AMF transmits, to the gNB, an NG setup response message or another message including QoS monitoring capability information of one or more network elements of a core network side.

In S503, the QoS monitoring capability information is synchronized from the core network to the gNB. For example, an IE (for example, a QoS Monitoring Capability CN) configured for representing a QoS Monitoring capability may be added to a message (for example, the NG setup response or the another message) transmitted by the AMF to the gNB, to indicate QoS Monitoring capability information of the core network element. The QoS Monitoring capability information may include the network congestion monitoring, the delay monitoring, the RTT monitoring, and the like, and may also include another monitoring item. To flexibly reflect different aspects of the QoS monitoring capability, the capability IE may use different bitmaps to indicate different QoS monitoring capability items of the core network element. For example, the QoS monitoring capability items included in the QoS monitoring capability information are sequentially the link delay, the round-trip time, the network congestion information, the network transmission rate, and the network delay jitter information. In this case, the bitmap may include five flag bits. Assuming that 1 represents support, and 0 represents no support, “10110” represents that the core network element supports link delay monitoring, does not support round-trip time monitoring, supports network congestion information monitoring, supports network transmission rate monitoring, and does not support network delay jitter information monitoring.

The QoS monitoring capability information interacted between the AMF and the gNB may be of one or more network elements in the core network. For example, the QoS monitoring capability information interacted between the AMF and the gNB may be of the AMF, or may be of the PCF, the SMF, or the UPF. In this case, the AMF is merely used as a node directly connected to the gNB and indicates QoS monitoring capability information of another core network element to the gNB.

In one or more embodiments of this disclosure, negotiation of the QoS monitoring-related information may be performed in a PDU session establishment process or modification process. The PDU session establishment process is used as an example. In this solution, it is assumed that the gNB and the 5GC network element do not learn the QoS monitoring-related information in advance. Instead, according to a normal PDU session establishment procedure, for one PDU session, a network element such as the PCF, the SMF, or the UPF is selected and the PDU session establishment process is performed. The related gNB and 5GC network element reach an agreement for the QoS monitoring-related information in the PDU session establishment process. Therefore, the QoS monitoring-related information may be interacted in the PDU session establishment process. Descriptions continue to be provided below by using an example in which the QoS monitoring-related information is the QoS monitoring capability information:

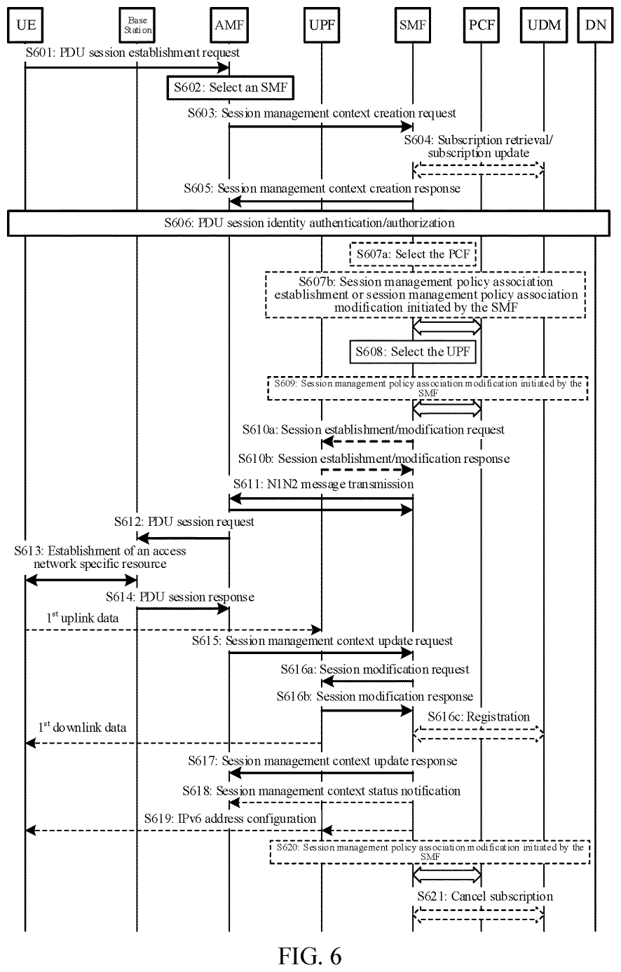

In at least one aspect, FIG. 6 shows a PDU session establishment procedure. The following describes a process in which the QoS monitoring capability information is used and interacted in the PDU session establishment procedure.

In at least one aspect, in S602 shown in FIG. 6, when selecting an SMF, an AMF may consider QoS monitoring capability information of the SMF, and the AMF may learn QoS monitoring capability information of a plurality of candidate SMFs according to the foregoing method or another method. For example, the AMF may obtain the QoS monitoring capability information of the plurality of candidate SMFs from a network repository function (NRF).

In S603 shown in FIG. 6, if the SMF selected by the AMF does not know QoS monitoring capability information of a gNB in advance, the AMF may add indication information to a session management context creation request, to indicate the QoS monitoring capability information of the gNB. In some embodiments, the AMF may further indicate QoS monitoring capability information of the AMF to the selected SMF by using the session management context creation request.

In S605 shown in FIG. 6, the SMF may indicate, in a session management context creation response message transmitted to the AMF, whether the SMF has the QoS monitoring capability information, where the QoS monitoring capability information may be stored in the AMF. The AMF regards the QoS monitoring capability information as QoS monitoring capability information of a per SMF. In some embodiments, whether the QoS monitoring capability information is started may depend on a per PDU session or a per user subscription.

In S607a shown in FIG. 6, when selecting a PCF, the SMF may consider QoS monitoring capability information of a candidate PCF. Further, in S607b shown in FIG. 6, the SMF may interact QoS monitoring capability information (which may be one or more of the QoS monitoring capability information of the gNB, the QoS monitoring capability information of the SMF, and the QoS monitoring capability information of the AMF) with the PCF.

In S608 shown in FIG. 6, when selecting a UPF, the SMF may consider QoS monitoring capability information of a candidate UPF. Further, in S610a and S610b shown in FIG. 6, the SMF interacts QoS monitoring capability information (which may be one or more of the QoS monitoring capability information of the gNB, the QoS monitoring capability information of the SMF, the QoS monitoring capability information of the AMF, and the QoS monitoring capability information of the PCF) with the UPF.

In S611 and S612 shown in FIG. 6, a core network element may provide QoS monitoring capability information of one or more network elements (for example, one or more the AMF, the SMF, the UPF, and the PCF) in the core network for the gNB.

In conclusion, the AMF may transmit the QoS monitoring capability information of the AMF and/or QoS monitoring capability information of another network element to the SMF by using one of the session management context creation request message (that is, a CreateSMContext Request) in S603, an N1N2 information transfer message (that is, N1N2MessageTransfer) in S613, and a session management context update request message (that is, an UpdateSMContext Request) in S615.

The AMF may further transmit the QoS monitoring capability information of the AMF and/or QoS monitoring capability information of another network element to the gNB by using a PDU session request message (that is, a PDU Session Request) in S612.

The SMF may transmit the QoS monitoring capability information of the SMF and/or the QoS monitoring capability information of the another network element to the AMF by using one of the session management context creation response message (that is, a CreateSMContext Response) in S605, an N1N2 information transfer message (that is, N1N2MessageTransfer) in S611, a session management context update response message (UpdateSM Context Response) in S617, and a session management context status notification message (that is, SMContextStatus Notify) in S618.

The SMF may further transmit the QoS monitoring capability information of the SMF and/or the QoS monitoring capability information of the another network element to the PCF by using a message in a session management policy association establishment process (that is, SM Policy Association Establishment) or a session management policy association modification process (that is, SM Policy Association Modification may alternatively be a modification process initiated by the SMF in S609 and S620) in S607b.

The SMF may further transmit the QoS monitoring capability information of the SMF and/or the QoS monitoring capability information of the another network element to the UPF by using a session establishment request message (that is, an N4 Session Modification Request) or a session modification request message (that is, an N4 Session Modification Request) in S610a.

The PCF may transmit the QoS monitoring capability information of the PCF and/or the QoS monitoring capability information of the another network element to the SMF by using the message in the session management policy association establishment process (that is, SM Policy Association Establishment) or the session management policy association modification process (that is, SM Policy Association Modification may alternatively be the modification process initiated by the SMF in S609 and S620) in S607b.

The UPF may transmit QoS monitoring capability information of the UPF and/or the QoS monitoring capability information of the another network element to the SMF by using a session establishment response message (that is, an N4 Session Establishment Response) or a session modification response message (that is, an N4 Session Modification Response) in S610b.

In one or more embodiments of this disclosure, after the PDU session is established, negotiation and interaction of the QoS monitoring capability may be implemented in a PDU session modification process (where a message configured for interacting the QoS monitoring capability information in the PDU session modification process is similar to some signaling in the procedure shown in FIG. 6), or by using independent signaling interaction. In a negotiation and interaction process, the network elements such as the gNB, the AMF, the SMF, the PCF, and the UPF reach an agreement for QoS monitoring capability items such as a UL delay, a DL delay, an RTT delay, network congestion information (which may be uplink network congestion information, downlink network congestion information, or uplink and downlink network congestion information), a network transmission rate (which may be an uplink network transmission rate, a downlink network transmission rate, or an uplink and downlink network transmission rate), and network delay jitter information (which may be uplink network delay jitter information, downlink network delay jitter information, or uplink and downlink network delay jitter information).

As such, one or more embodiments of this disclosure can allow to synchronize the QoS monitoring-related information between the network elements, so that the network elements in the network can work more collaboratively, and a consistent QoS monitoring capability is provided. This helps improve quality of service and reliability of a target application such as industrial control or remote driving, thereby better satisfying requirements for real-time control and data transmission.

The following describes apparatus embodiment of this disclosure, and the apparatus embodiment may be configured to perform the communication methods in the foregoing embodiment of this disclosure. For details not disclosed in the apparatus embodiment of this disclosure, refer to the foregoing communication method embodiment of this disclosure.

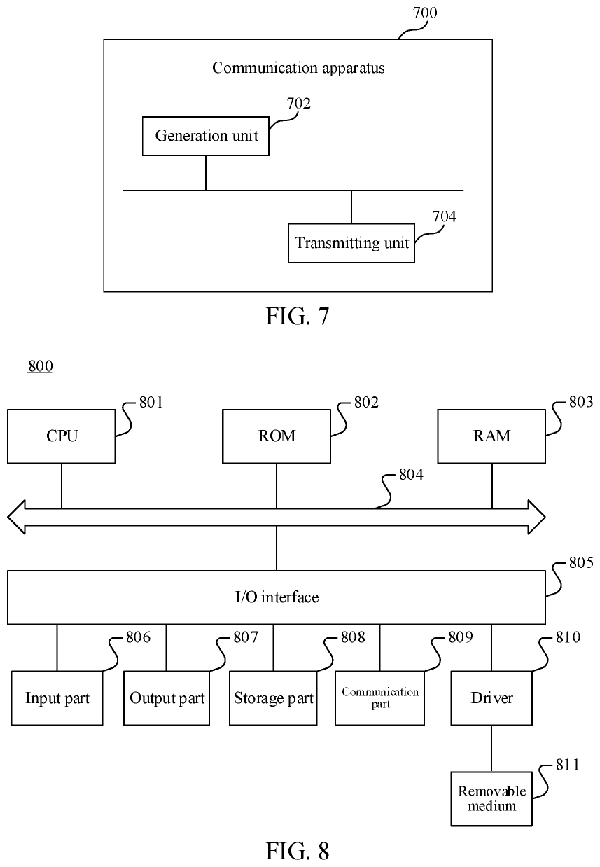

FIG. 7 is a block diagram of a communication apparatus according to an embodiment of this disclosure. The communication apparatus is used in a first network element. The first network element may be an access network element such as a base station. The first network element may alternatively be a core network element, for example, another network element such as an AMF, an SMF, a UPF, or a PCF.

With reference to FIG. 7, a communication apparatus 700 according to one or more embodiments of this disclosure is provided. The apparatus includes a generation unit 702 and a transmitting unit 704.

The generation unit 702 is configured to generate a first message, and the first message includes QoS monitoring-related information of the first network element. The transmitting unit 704 is configured to transmit the first message to a second network element, to synchronize the QoS monitoring-related information of the first network element to the second network element.

In some embodiments of this disclosure, based on the foregoing solution, the communication apparatus 700 further includes: a receiving unit, configured to receive a second message transmitted by the second network element, the second message includes QoS monitoring-related information of the second network element, or the second message includes QoS monitoring-related information of another network element interacting with the second network element, or the second message includes the QoS monitoring-related information of the second network element and the QoS monitoring-related information of the another network element interacting with the second network element.

In some embodiments of this disclosure, based on the foregoing solution, the first network element includes an access network element, and the first message including an NG interface setup request message. The transmitting unit 704 is configured to transmit the NG interface setup request message to the access and mobility management function (AMF), to enable the AMF to determine QoS monitoring-related information of the access network element or transfer the QoS monitoring-related information of the access network element to another core network element.

In some embodiments of this disclosure, based on the foregoing solution, the NG interface setup request message includes a first information element, and the first information element indicates the QoS monitoring-related information of the access network element.

In some embodiments of this disclosure, based on the foregoing solution, the QoS monitoring-related information includes QoS monitoring capability information, an element value corresponding to the first information element includes at least one flag bit, each flag bit corresponds to one QoS monitoring capability item, and a value of the flag bit indicates whether the access network element supports a corresponding QoS monitoring capability item.

In some embodiments of this disclosure, based on the foregoing solution, the communication apparatus 700 further includes: a receiving unit, configured to receive an NG interface setup response message fed back by the AMF for the NG interface setup request message, the NG interface setup response message including QoS monitoring-related information of the core network element; and the QoS monitoring-related information of the core network element includes at least one of the following: QoS monitoring-related information of the AMF, QoS monitoring-related information of a session management function (SMF), QoS monitoring-related information of a policy control function (PCF), and QoS monitoring-related information of a user plane function (UPF).

In some embodiments of this disclosure, based on the foregoing solution, the NG interface setup response message includes a second information element, and the second information element indicates the QoS monitoring-related information of the core network element.

In some embodiments of this disclosure, based on the foregoing solution, the QoS monitoring-related information includes the QoS monitoring capability information, an element value corresponding to the second information element includes at least one flag bit, each flag bit corresponds to one QoS monitoring capability item, and a value of the flag bit indicates whether the core network element supports a corresponding QoS monitoring capability item.

In some embodiments of this disclosure, based on the foregoing solution, the first network element includes the access network element. The transmitting unit 704 is configured to transmit the first message to the UPF through a user plane, to enable the UPF to determine the QoS monitoring-related information of the access network element or transfer the QoS monitoring-related information of the access network element to a performance measurement function (PMF).

In some embodiments of this disclosure, based on the foregoing solution, the first network element includes the AMF; and the second network element is the SMF if the first message is one of a session management context creation request message, an N1N2 information transfer message, and a session management context update request message; or the second network element is the access network element if the first message is a protocol data unit (PDU) session request message.

In some embodiments of this disclosure, based on the foregoing solution, the first network element includes the SMF; and the second network element is the AMF if the first message is one of a session management context creation response message, an N1N2 information transfer message, a session management context update response message, and a session management context status notification message; the second network element is the PCF if the first message is a message in a session management policy association establishment process or a session management policy association modification process; or the second network element being the UPF if the first message is a session establishment request message or a session modification request message.

In some embodiments of this disclosure, based on the foregoing solution, the first message is the message in the session management policy association establishment process or the session management policy association modification process if the first network element is the PCF, and the second network element is the SMF; or the first message is the session establishment response message or the session modification response message if the first network element is the UPF, and the second network element being the SMF.

In some embodiments of this disclosure, based on the foregoing solution, the communication apparatus 700 further includes a selection unit, and the selection unit is configured to perform at least one of the following processes: if the first network element is an AMF, selecting, based on the QoS monitoring-related information of an SMF in a PDU session establishment process, an SMF configured for establishing a PDU session; if the first network element is an SMF, selecting, based on the QoS monitoring-related information of a PCF in a PDU session establishment process, a PCF configured for establishing a PDU session; and if the first network element is an SMF, selecting, based on the QoS monitoring-related information of a UPF in a PDU session establishment process, a UPF configured for establishing a PDU session.

In some embodiments of this disclosure, based on the foregoing solution, the first message further includes QoS monitoring-related information of another network element interacting to the first network element.

In some embodiments of this disclosure, based on the foregoing solution, the QoS monitoring-related information includes at least one of the following: QoS monitoring configuration information, QoS monitoring parameter information, and the QoS monitoring capability information.

FIG. 8 is a schematic diagram of a structure of a computer system suitable for implementing the embodiments of this disclosure. The electronic device may be the network element in the foregoing the embodiment.

A computer system 800 of the electronic device shown in FIG. 8 is an example, and does not bring any limitation to the function and use scope of the embodiments of this disclosure.

As shown in FIG. 8, the computer system 800 may include processing circuitry, such as a central processing unit (CPU) 801. In some examples, the processing circuitry may be configured to perform various suitable actions and processing based on a program stored in a non-transitory computer-readable storage medium (such as a read-only memory (ROM) 802) or a program loaded from a storage part 808 to a random access memory (RAM) 803, for example, perform the method described in the foregoing embodiments. The RAM 803 further has various programs and data required for a system operation stored therein. The CPU 801, the ROM 802, and the RAM 803 are connected to each other through a bus 804. An input/output (I/O) interface 805 is also connected to the bus 804.

The following components may be connected to the I/O interface 805: an input part 806 including a keyboard, a mouse, and the like; an output part 807 including a cathode ray tube (CRT), a liquid crystal display (LCD), a speaker, and the like; a storage part 808 including a hard disk and the like; and a communication part 809 including a network interface card such as a local area network (LAN) card or a modem. The communication part 809 performs communication processing by using a network such as the Internet. A driver 810 is also connected to the I/O interface 805 as required. A removable medium 811, such as a magnetic disk, an optical disc, a magneto-optical disk, or a semiconductor memory, is mounted on the driver 810 as required, so that a computer program read from the removable medium is installed into the storage part 808 as required.

Particularly, according to an embodiment of this disclosure, the processes described in the foregoing by referring to the flowcharts may be implemented as a computer software program. For example, this disclosure includes a computer program product. The computer program product includes a computer program stored in a non-transitory computer-readable storage medium, and the computer program is configured for performing the methods shown in the flowcharts. In such an embodiment, the computer program may be downloaded and installed from the network through the communication part 809, and/or installed from the removable medium 811. When the computer program is executed by processing circuitry (e.g., the CPU 801), the various functions defined in the system of this disclosure are executed.

A computer-readable medium shown in this disclosure may be a computer-readable signal medium, a non-transitory computer-readable storage medium, or any combination thereof. The non-transitory computer-readable storage medium may be, for example, but is not limited to, an electrical, a magnetic, an optical, an electromagnetic, an infrared, or a semiconductor system, apparatus or component, or any combination thereof. In some examples, the non-transitory computer-readable storage medium may include but are not limited to: an electrical connection having one or more conductors, a portable computer disk, a hard disk, an RAM, an ROM, an erasable programmable read only memory (EPROM), a flash memory, an optical fiber, a portable compact disc read-only memory (CD-ROM), an optical storage component, a magnetic storage component, or any appropriate combination thereof. In this disclosure, the non-transitory computer-readable storage medium may be any tangible medium including or storing the computer program, and the program may be used by or used in combination with an instruction execution system, apparatus, or component. In this disclosure, the computer-readable signal medium may include a data signal transmitted in a baseband or as part of a carrier, and has a computer-readable computer program carried therein. The data signal propagated in such a way may be in a plurality of forms, including but not limited to, an electromagnetic signal, an optical signal, or any appropriate combination thereof. The computer-readable signal medium may further be any computer-readable medium other than the non-transitory computer-readable storage medium. The computer-readable medium may transmit, propagate, or transmit the program used by or in combination with the instruction execution system, apparatus or component. The computer program included in the computer-readable medium may be transmitted by using any suitable media including but not limited to: a wireless medium, a wired medium, or any suitable combination thereof.

The flowcharts and block diagram in the accompanying drawings illustrate possible system architectures, functions, and operations that may be implemented by the system, the method, and the computer program product according to various embodiments of this disclosure. Each block in the flowchart or the block diagram may represent a module, a program segment, or a part of code. The module, program segment, or part of code includes one or more executable instructions configured for implementing defined logical functions. In some implementations used as substitutes, functions specified in the blocks may be alternatively performed in a different order than that specified in the accompanying drawing. For example, two blocks shown in succession may actually be performed substantially in parallel, or may sometimes be performed in a reverse order, which depends on the functions involved. Each block in the block diagram or flowchart, and a combination of blocks in the block diagram or flowchart may be implemented by using a dedicated hardware-based system configured for performing a specified function or operation, or may be implemented by using a combination of dedicated hardware and the computer program.

The units involved in this disclosure may be implemented by using software or may be implemented by using hardware, and the described units may further be provided in a processor. Names of these units do not constitute a limitation on the units in a case.

In another aspect, this disclosure further provides a computer-readable medium. The computer-readable medium may be included in the electronic device described in the foregoing embodiments, or may exist alone without being mounted to the electronic device. The foregoing computer-readable medium carries one or more computer programs. The one or more computer programs, when executed by the electronic device, enable the electronic device to implement the methods described in the foregoing embodiments.

Although a plurality of modules or units of a device configured to perform actions are mentioned in the foregoing detailed description, such division is not mandatory. Actually, based on implementations of this disclosure, features and functions of two or more modules or units described above may be specified in one module or unit. In some examples, the features and the functions of one module or unit described above may be further divided to be specified by the plurality of modules or units.

Through the descriptions of the foregoing implementations, a person skilled in the art understands that the implementations described herein may be implemented by using the software, or may be implemented by using the software in combination with necessary hardware. Therefore, one or more embodiments of this disclosure may be embodied in a form of a software product. The software product may be stored in a non-volatile storage medium (which may be a CD-ROM, a universal serial bus (USB) disk, a removable hard disk, or the like) or on a network, including a plurality of instructions to enable an electronic device to perform the method according to the implementations of this disclosure.

For example, the electronic device may be a network element device, and then the network element device may perform the communication method shown in FIG. 3.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

In view of this specification and practicing the examples disclosed herein, a person skilled in the art may conceive of other implementation solutions or variations of this disclosure. Any variations, uses, or adaptive changes follow the general principles of this disclosure shall fall within the scope of this disclosure. This application is not limited to the precise structures described above and shown in the accompanying drawings, and various modifications and changes may be made without departing from the scope of this disclosure.

What is claimed is:

1. A communication method, the communication method comprising:
generating a first message by processing circuitry of a communication device configured as a first network element in a communication network, the first message including quality of service (QoS) monitoring-related information of the first network element, and the QoS monitoring-related information including QoS monitoring capability information indicating a QoS monitoring capability supported by the first network element; and
transmitting the first message to a second network element in the communication network irrespective of whether the first network element is configured to perform a QoS monitoring operation.

2. The communication method according to claim 1, wherein the first message is transmitted to the second network element during an interface establishment process, a network element discovery process, a protocol data unit (PDU) session establishment process, or a PDU session modification process.

3. The communication method according to claim 1, further comprising:
receiving, by the first network element, a second message from the second network element, the second message including one or more of:
QoS monitoring-related information of the second network element, or QoS monitoring-related information of another network element that interacts with the second network element.

4. The communication method according to claim 1, wherein
the first network element corresponds to an access network element in the communication network,
the second network element corresponds to an access and mobility management function (AMF),
the first message corresponds to an NG interface setup request message, and
the second network element is configured to determine QoS monitoring-related information of the access network element or transfer the QoS monitoring-related information of the access network element to another core network element based on the first message.

5. The communication method according to claim 4, wherein the NG interface setup request message includes a first information element indicating the QoS monitoring-related information of the access network element.

6. The communication method according to claim 5, wherein
the first information element includes at least one flag bit,
each flag bit of the at least one flag bit corresponds to a respective QoS monitoring capability item, and
a value of each flag bit of the at least one flag bit indicates whether the access network element supports the respective QoS monitoring capability item.

7. The communication method according to claim 4, further comprising:
receiving, by the first network element, a NG interface setup response message from the second network element with respect to the NG interface setup request message, the NG interface setup response message including QoS monitoring-related information of a core network element,
wherein the QoS monitoring-related information of the core network element includes at least one of: QoS monitoring-related information of the AMF, QoS monitoring-related information of a session management function (SMF), QoS monitoring-related information of a policy control function (PCF), or QoS monitoring-related information of a user plane function (UPF).

8. The communication method according to claim 7, wherein the NG interface setup response message includes a second information element indicating the QoS monitoring-related information of the core network element.

9. The communication method according to claim 8, wherein
the second information element includes at least one flag bit indicating QoS monitoring capability information of the core network element,
each flag bit of the at least one flag bit corresponds to a respective QoS monitoring capability item, and
a value of each flag bit of the at least one flag bit indicates whether the core network element supports the respective QoS monitoring capability item.

10. The communication method according to claim 1, wherein
the first network element corresponds to an access network element in the communication network,
the second network element corresponds to a user plane function (UPF), and
the second network element is configured to determine QoS monitoring-related information of the access network element or transfer the QoS monitoring-related information of the access network element to a performance measurement function (PMF) based on the first message.

11. The communication method according to claim 1, wherein
the first network element corresponds to an access and mobility management function (AMF), and
the second network element corresponds to
a session management function (SMF) when the first message is one of a session management context creation request message, an N1N2 information transfer message, or a session management context update request message, or
an access network element when the first message is a protocol data unit (PDU) session request message.

12. The communication method according to claim 1, wherein
the first network element corresponds to a session management function (SMF), and
the second network element corresponds to
an access and mobility management function (AMF) when the first message is one of a session management context creation response message, an N1N2 information transfer message, a session management context update response message, or a session management context status notification message,
a policy control function (PCF) when the first message is a message in a session management policy association establishment process or a session management policy association modification process, or
a user plane function (UPF) when the first message is a session establishment request message or a session modification request message.

13. The communication method according to claim 1, wherein
when the first network element corresponds to a policy control function (PCF) and the second network element corresponds to a session management function (SMF), the first message corresponds to a message in a session management policy association establishment process or a session management policy association modification process, or
when the first network element corresponds to a user plane function (UPF) and the second network element corresponds to the SMF, the first message corresponds to a session establishment response message or a session modification response message.

14. The communication method according to claim 1, further comprising at least one of:
when the first network element corresponds to an access and mobility management function (AMF), selecting, based on QoS monitoring-related information of one or more session management function (SMF) network elements in a first protocol data unit (PDU) session establishment process, a target SMF for establishing a first PDU session;
when the first network element is an SMF, selecting, based on QoS monitoring-related information of one or more policy control function (PCF) network elements in a second PDU session establishment process, a target PCF for establishing a second PDU session; or
when the first network element is the SMF, selecting, based on QoS monitoring-related information of one or more user plane function (UPF) network elements in a third PDU session establishment process, a target UPF for establishing a third PDU session.

15. The communication method according to claim 1, wherein
the first message further includes QoS monitoring-related information of another network element interacting with the first network element.

16. The communication method according to claim 1, wherein the QoS monitoring-related information further includes at least one of QoS monitoring configuration information or QoS monitoring parameter information.

17. A communication device configured as a first network element in a communication network, the communication device comprising:
processing circuitry configured to:
generate a first message that includes quality of service (QoS) monitoring-related information of the first network element, and the QoS monitoring-related information including QoS monitoring capability information indicating a QoS monitoring capability supported by the first network element; and
transmit the first message to a second network element in the communication network irrespective of whether the first network element is configured to perform a QoS monitoring operation.

18. The communication device according to claim 17, wherein the first message is transmitted to the second network element during an interface establishment process, a network element discovery process, a protocol data unit (PDU) session establishment process, or a PDU session modification process.

19. The communication device according to claim 17, wherein the processing circuitry is configured to:
receive a second message from the second network element, the second message including one or more of:
QoS monitoring-related information of the second network element, or
QoS monitoring-related information of another network element interacting with the second network element.

20. A non-transitory computer-readable storage medium storing instructions, which when executed by a processor of a communication device configured as a first network element, cause the processor to perform a communication method comprising:
generating a first message that includes quality of service (QoS) monitoring-related information of the first network element, and the QoS monitoring-related information including QoS monitoring capability information indicating a QoS monitoring capability supported by the first network element; and
transmitting the first message to a second network element in the communication network irrespective of whether the first network element is configured to perform a QoS monitoring operation.
